(19) United States
(12) Patent Application Publication
(10) Pub. No.: US 2012/0019736 A1
(43) Pub. Date: Jan. 26, 2012

(54) IMAGING DEVICE

(75) Inventors: Kenji Yamamoto, Kanagawa (JP); Shinichiro Tajiri, Tokyo (JP)

(73) Assignee: SONY CORPORATION, Tokyo (JP)

(21) Appl. No.: 13/262,994

(22) PCT Filed: Apr. 15, 2010
(86) PCT No.: PCT/JP2010/056763

§ 371 Date: Oct. 5, 2011

(30) Foreign Application Priority Data
Apr. 17, 2009 (JP) P2009-101193
Apr. 6, 2010 (JP) P2010-087970

(51) Int. Cl. G02F 1/1335

(52) U.S. Cl. 349/15

(57) ABSTRACT

An imaging device capable of obtaining desired visual point images without the attitude at a time of photographing being limited to one direction is provided. The imaging device 2 includes: an imaging lens 11; an imaging element 13 for obtaining imaging data on a basis of received light; a liquid crystal shutter 19 divided into four or more regions, the liquid crystal shutter 19 being capable of controlling transmittance in each of the regions; a liquid crystal shutter driving section 14 for switching between transmission and blockage in each of the regions in the liquid crystal shutter 19; and a casing in which the imaging lens, the imaging element, and the liquid crystal shutter are housed. Because the liquid crystal shutter 19 is divided into four or more regions, the liquid crystal shutter driving section 14 can select appropriate regions corresponding to desired visual point directions from the four or more regions and switch between transmission and blockage in each of a case where the casing is in one attitude and a case where the casing is in another attitude different from the one attitude.

### TECHNICAL FIELD

The present invention relates to an imaging device suitable for obtaining parallax images used for three-dimensional display, for example.

### BACKGROUND ART

In the related art, various imaging devices have been proposed and developed. In addition, imaging devices that subject imaging data obtained by imaging to predetermined image processing and output the result have been proposed.

Patent Document 1, for example, proposes an imaging device with an electronic optical shutter using a liquid crystal (which shutter will hereinafter be referred to simply as a liquid crystal shutter). This imaging device includes an imaging lens, a liquid crystal shutter, an imaging element, and an image processing section. The liquid crystal shutter is divided into two regions, and switching between transmission and blockage in each of the regions can be performed. Thereby, images are obtained on the basis of a light beam transmitted by each transmitting region of the liquid crystal shutter. The images are generated on the basis of the light beam transmitted by different regions of the liquid crystal shutter, and are thus parallax images having a parallax with respect to each other. Two such parallax images are each displayed by using a special display device, and are separately observed by the right eye and the left eye of an observer. Thereby a stereoscopy can be realized.

### PRIOR ART DOCUMENT

### Patent Document

Patent Document 1: Japanese Patent Laid-Open No. 2001-61165

### SUMMARY OF INVENTION

However, in the imaging device as described above, two regions into which the liquid crystal shutter is divided are arranged along one direction, for example a horizontal direction (left-to-right direction) for obtaining a left visual point image and a right visual point image. Thus, when such an imaging device is used as for example a camera or the like, the attitude of the camera at a time of photographing is always limited to a certain attitude in order to obtain a left visual point image and a right visual point image. That is, the liquid crystal shutter divided into two regions (hereinafter referred to simply as a two-part split shutter) is restricted by the attitude of the camera, and it is difficult to obtain desired visual point images (for example a left visual point image and a right visual point image) in a state in which the camera is inclined (rotated) by a predetermined angle, for example.

The present invention has been made in view of such problems. It is an object of the present invention to provide an imaging device capable of obtaining desired visual point images without the attitude at a time of photographing being limited to one direction.

An imaging device according to one embodiment of the present invention includes: an imaging lens; an imaging element for obtaining imaging data on a basis of received light; a liquid crystal shutter divided into at least four regions, the liquid crystal shutter being capable of controlling transmittance of a light beam going toward the imaging element in each of the regions; a liquid crystal shutter driving section configured to switch between transmission and blockage in each of the regions in the liquid crystal shutter; and a casing in which the imaging lens, the imaging element, and the liquid crystal shutter are housed. The liquid crystal shutter driving section switches between transmission and blockage in each of the regions in the liquid crystal shutter according to the attitude of the casing. Incidentally, the “attitude” in the present invention refers to the state of inclination (rotational state) of the casing in a plane parallel to the light receiving surface of the imaging element.

In the imaging device according to one embodiment of the present invention, the liquid crystal shutter driving section switches between transmission and blockage in each of the regions of the liquid crystal shutter, whereby the imaging element obtains imaging data based on the received light beam in each region. Because the plurality of regions in the liquid crystal shutter are regions different from each other, light beams transmitted by the respective regions mutually have a parallax. At this time, because the liquid crystal shutter is divided into four or more regions, the liquid crystal shutter driving section can select appropriate regions corresponding to desired visual point directions from the four or more regions and switch between transmission and blockage in each of a case where the casing is in one attitude and a case where the casing is in another attitude different from the one attitude.

In accordance with the imaging device according to one embodiment of the present invention, the liquid crystal shutter is divided into at least four regions, and the liquid crystal shutter driving section switches between transmission and blockage in each of the regions of the liquid crystal shutter according to the attitude of the casing. Thereby, in not only the case where the casing is in one attitude but also the case where the casing is in another attitude different from the one attitude, it is possible to select appropriate regions corresponding to desired visual point directions, and switch between transmission and blockage in these regions. That is, desired visual point images can be obtained even when the casing is in one of the above-described attitudes. Hence, desired visual point images can be obtained without the attitude at a time of photographing being limited to one direction.

### BRIEF DESCRIPTION OF DRAWINGS

[FIG. 1]

FIG. 1 is a block diagram showing a configuration of an imaging device according to a first embodiment of the present invention.

[FIG. 2]

FIG. 2 shows schematic plan views showing region division and directions of polarization of a liquid crystal shutter shown in FIG. 1.

[FIG. 3]

FIG. 3 is a sectional view of a boundary between sub-regions and the vicinity thereof in the liquid crystal shutter shown in FIG. 1.

[FIG. 4]

FIG. 4 is a schematic diagram showing respective plane configurations of a polarizer, sub-electrodes, and an analyzer shown in FIG. 3.

[FIG. 5]

FIG. 5 is a schematic plan view showing another example of the polarizer shown in FIG. 4.

[FIG. 6]

FIG. 6 is a diagram showing a sectional configuration of a liquid crystal shutter according to a first comparative example and plane configurations of a polarizer, an electrode, and an analyzer of the liquid crystal shutter.

[FIG. 7]

FIG. 7 is a schematic diagram of assistance in explaining action of the liquid crystal shutter shown in FIG. 6.

[FIG. 8]

FIG. 8 is a diagram showing plane configurations of a polarizer, an electrode, and an analyzer of a liquid crystal shutter according to a second comparative example.

[FIG. 9]

FIG. 9 is a schematic diagram of assistance in explaining action of the liquid crystal shutter shown in FIG. 8.

[FIG. 10]

FIG. 10 shows schematic diagrams of assistance in explaining an example of application of the imaging device shown in FIG. 1.

[FIG. 11]

FIG. 11 is a sectional view of a schematic configuration of a liquid crystal shutter according to a second embodiment of the present invention.

[FIG. 12]

FIG. 12 is a schematic diagram showing respective plane configurations of a polarizer, sub-electrodes, and an analyzer shown in FIG. 11.

[FIG. 13]

FIG. 13 is a schematic plan view of another example of a polarizer shown in FIG. 12.

[FIG. 14]

FIG. 14 shows schematic plan views showing region division and directions of polarization of a liquid crystal shutter according to a first example of modification.

[FIG. 15]

FIG. 15 shows schematic plan views showing region division and directions of polarization of a liquid crystal shutter according to a second example of modification.

[FIG. 16]

FIG. 16 is a block diagram showing a constitution of an imaging device according to a third embodiment of the present invention.

[FIG. 17]

FIG. 17 is a schematic plan view of a schematic constitution of a liquid crystal shutter (four divisions) according to the third embodiment of the present invention.

[FIG. 18]

(A) shows a sectional constitution of a liquid crystal shutter shown in FIG. 16 and an example of an electrode division pattern, and (B) to (D) show an example of other electrode division patterns.

[FIG. 19]

FIG. 19 is a flowchart of an imaging data obtaining process in the third embodiment.

[FIG. 20]

FIG. 20 shows schematic diagrams of assistance in explaining a shutter switching operation using the liquid crystal shutter shown in FIG. 16, (A) to (C) showing a 0° attitude, and (D) to (F) showing a 90° attitude.

[FIG. 21]

FIG. 21 shows schematic diagrams of assistance in explaining another shutter switching operation using the liquid crystal shutter shown in FIG. 16, (A) and (B) representing a case where a left visual point image and a right visual point image are obtained, and (C) and (D) representing a case where an upper visual point image and a lower visual point image are obtained.

[FIG. 22]

FIG. 22 is a schematic plan view of a schematic constitution of a liquid crystal shutter (eight divisions) according to a third example of modification.

[FIG. 23]

FIG. 23 shows a sectional constitution of a liquid crystal shutter shown in FIG. 21 and an example of an electrode division pattern.

[FIG. 24]

FIG. 24 shows schematic diagrams of assistance in explaining a shutter switching operation using the liquid crystal shutter shown in FIG. 21, (A) to (C) showing a 0° attitude, and (D) to (F) showing a 90° attitude.

[FIG. 25]

FIG. 25 shows schematic diagrams of assistance in explaining a shutter switching operation using the liquid crystal shutter shown in FIG. 21, (A) to (C) showing a 45° attitude, and (D) to (F) showing a −45° attitude.

[FIG. 26]

FIG. 26 shows schematic diagrams of assistance in explaining another shutter switching operation.

### MODES FOR CARRYING OUT THE INVENTION

Preferred embodiments of the present invention will hereinafter be described in detail with reference to the drawings. Incidentally, description will be made in the following order.

### 1. First Embodiment: Example of Dividing Each Region of Liquid Crystal Shutter by Sub-Electrode Formation (Electrode Division)

### 2. Second Embodiment: Example of Dividing Each Region of Liquid Crystal Shutter by Polarizing Region Division in Analyzer (Second Polarizer)

3. First Example of Modification: Example of Dividing Each Region into Four Sub-Regions
4. Second Example of Modification: Another Example of Dividing Each Region into Four Sub-Regions

### 5. Third Embodiment: Example of Imaging Device Having Attitude Detecting Mechanism (Liquid Crystal Shutter: Four Divisions)

### 6. Third Example of Modification: Example Using Another Liquid Crystal Shutter (Eight Divisions)

### First Embodiment

### (Configuration of Imaging Device 1)

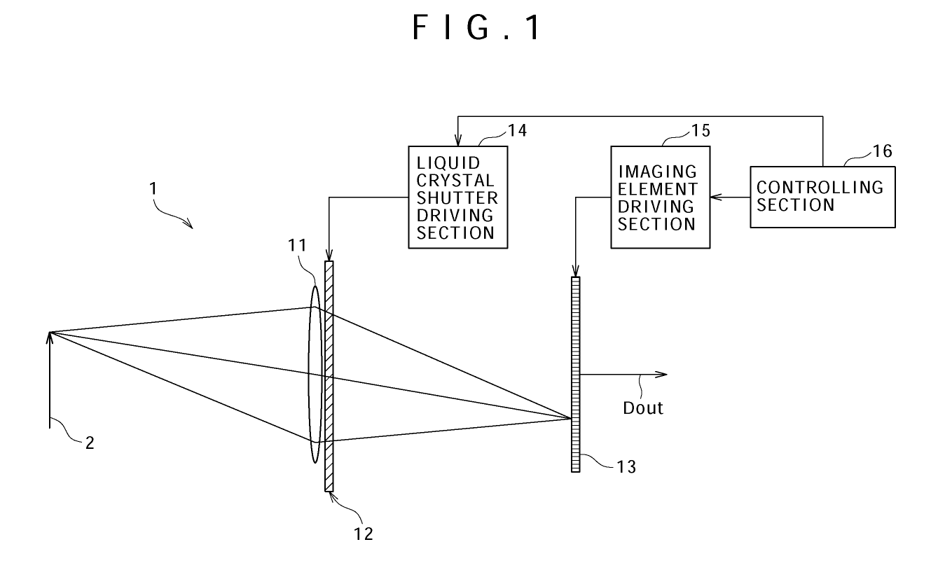

FIG. 1 shows a general configuration of an imaging device (imaging device 1) according to a first embodiment of the present invention. The imaging device 1 images an image of an imaging object 2, and outputs imaging data Dout. The imaging device 1 includes an imaging lens 11, a liquid crystal shutter 12, an imaging element 13, a liquid crystal shutter driving section 14, an imaging element driving section 15, and a controlling section 16. Incidentally, the imaging device 1 may have an image processing section not shown in the figure.

The imaging lens 11 is a main lens for imaging an image of the imaging object 2. For example an ordinary imaging lens used in a video camera, a still camera or the like is used as the imaging lens 11.

The liquid crystal shutter 12 is to control the transmittance of a light beam directed to the imaging element 13. The liquid crystal shutter 12 is disposed on the light incidence side or the light emission side (light emission side in this case) of the imaging lens 11. A detailed configuration of the liquid crystal shutter 12 will be described later.

The imaging element 13 obtains imaging data by receiving the light from the imaging lens 11. The imaging element 13 is disposed in the focal plane of the imaging lens 11. The imaging element 13 is for example formed by arranging a CCD (Charge Coupled Device), a CMOS (Complementary Metal Oxide Semiconductor) or the like in the form of a matrix. Color filters of R, G, and B (not shown) which color filters have a predetermined color arrangement, for example, are disposed on the light receiving surface of the imaging element 13.

The liquid crystal shutter driving section 14 drives the liquid crystal shutter 12 to perform control for switching between transmission (open) and blockage (close) in two regions of the liquid crystal shutter 12 on a time division basis. The switching operation of the liquid crystal shutter driving section 14, which switching operation will be described later in detail, is performed by changing a voltage supplied to the liquid crystal shutter 12.

The imaging element driving section 15 drives the imaging element 13 to control the light receiving operation of the imaging element 13.

The controlling section 16 controls the operation of the liquid crystal shutter driving section 14 and the imaging element driving section 15. For example a microcomputer is used as the controlling section 16.

### (Detailed Configuration of Liquid Crystal Shutter 12)

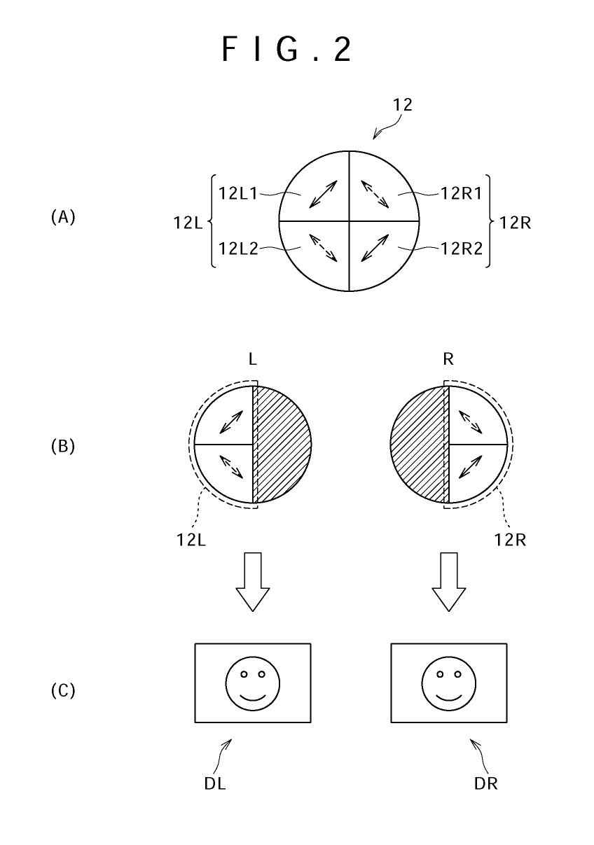

First, an outline of region divisions in the liquid crystal shutter 12 will be described with reference to FIGS. 2(A) and 2(B). FIGS. 2(A) and 2(B) schematically show region divisions and directions of polarization in the liquid crystal shutter 12. Each of arrows in respective sub-regions schematically indicates a direction of polarization. The liquid crystal shutter 12 has two regions different from each other (two left and right regions in this case) 12L and 12R. The regions 12L and 12R are provided so as to be symmetric with respect to an optical axis, for example so as to divide a circular plane shape into two left and right parts. Such a liquid crystal shutter 12 can control the transmittance of a light beam (specifically switch between transmission and blockage) in each of the regions 12L and 12R (FIG. 2(B)). In FIG. 2(B), hatched parts indicate that the light beam is blocked (close). That is, the region 12L is open on the left (L) of the figure, and the region 12R is open on the right (R) of the figure.

The regions 12L and 12R are divided into sub-regions that respectively transmit polarized light in different directions of polarization from each other. For example, the region 12L is divided into equal sub-regions 12L1 and 12L2. Of the regions 12L1 and 12L2, the region 12L1 selectively transmits first polarized light (solid line arrow, which will be similarly used in the following), and the region 12L2 selectively transmits second polarized light (dotted line arrow, which will be similarly used in the following). The region 12R is similarly divided into equal sub-regions 12R1 and 12R2, the sub-region 12R1 transmitting the second polarized light, and the sub-region 12R2 transmitting the first polarized light. However, in the present specification, the “first polarized light” and the “second polarized light” are linearly polarized light whose directions of polarization are orthogonal to each other (pieces of light that vibrate in a 0° direction and a 90° direction, respectively), and for example one of the “first polarized light” and the “second polarized light” is p-polarized light, and the other is s-polarized light.

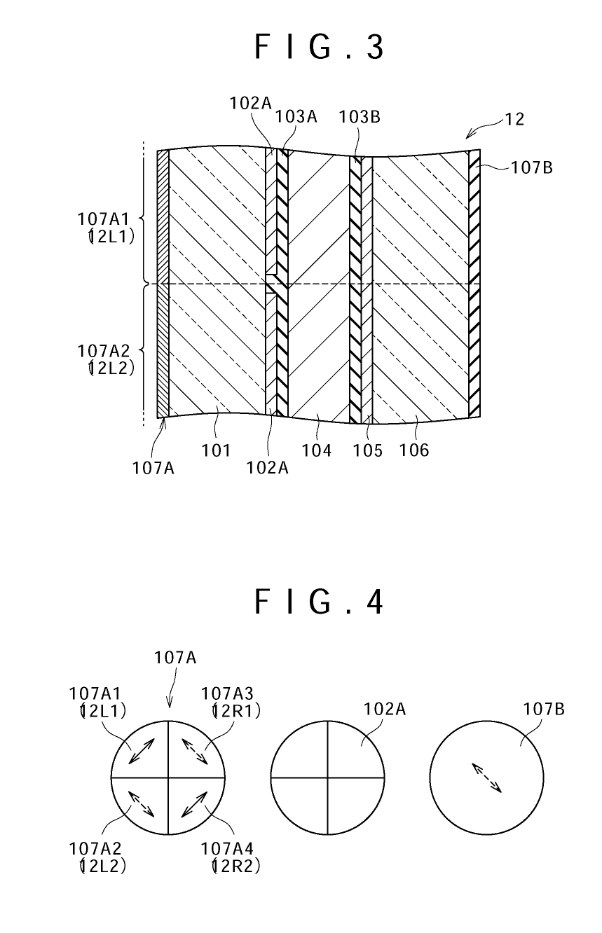

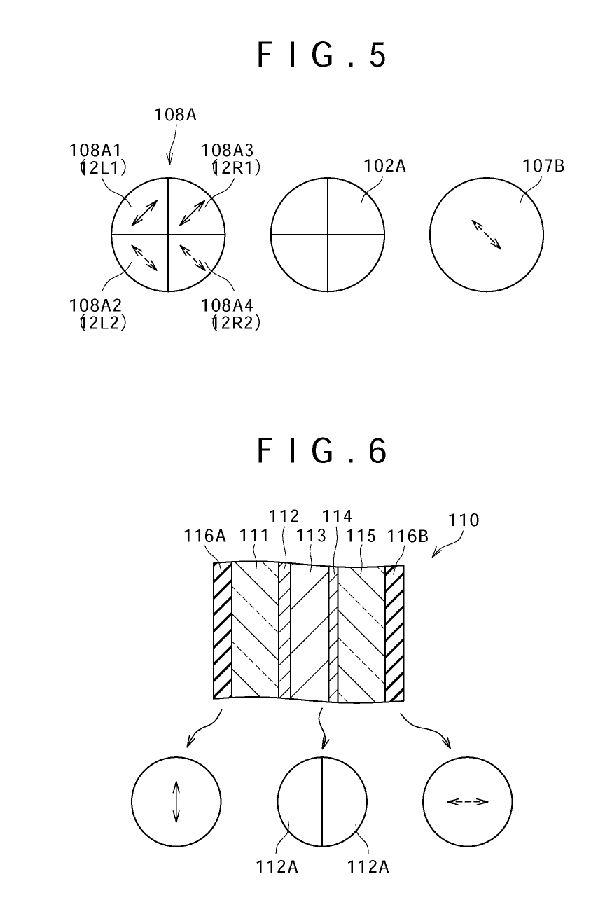

In the liquid crystal shutter 12, the region division as described above is performed by dividing a polarizer and an electrode. A concrete configuration of the liquid crystal shutter 12 will hereinafter be described with reference to FIG. 3 and FIG. 4. FIG. 3 shows a sectional configuration around a boundary between the sub-regions 12L1 and 12L2 in the liquid crystal shutter 12. FIG. 4 schematically shows respective plane configurations of a polarizer, a sub-electrode, and an analyzer. FIG. 5 shows another example of plane configuration of the polarizer.

The liquid crystal shutter 12 has a liquid crystal layer 104 sealed in between a pair of substrates 101 and 106, has a polarizer 107A (first polarizer) laminated to the light incidence side of the substrate 101, and has an analyzer 107B (second polarizer) laminated to the light emission side of the substrate 106. The substrates 101 and 106 are each a transparent substrate such for example as a glass substrate, and are able to transmit an incident light beam.

An electrode is formed between the substrate 101 and the liquid crystal layer 104, and the electrode in the present embodiment is divided into a plurality of sub-electrodes (four sub-electrodes in this case) 102A. The four sub-electrodes 102A are formed so as to divide the plane shape of the liquid crystal shutter 12 into equal parts radially. The four sub-electrodes 102A correspond to the sub-regions 12L1, 12L2, 12R1, and 12R2 in the liquid crystal shutter 12. Such an electrode division enables transmittance control in each of the regions 12L and 12R.

On the other hand, an electrode 105 common to the sub-regions 12L1, 12L2, 12R1, and 12R2 is formed on the substrate 106 opposed to the substrate 101. An alignment film 103A is formed between the sub-electrodes 102A and the liquid crystal layer 104, and an alignment film 103B is formed between the electrode 105 and the liquid crystal layer 104.

The sub-electrodes 102A and the electrode 105 are each formed by a transparent electrode such for example as an ITO (Indium Tin Oxide), and are able to transmit an incident light beam as with the substrates 101 and 106. The alignment films 103A and 103B are to align liquid crystal molecules within the liquid crystal layer 104 in a desired direction. In the present embodiment, respective alignment control directions of the alignment film 103A and the alignment film 103B in alignment control on the liquid crystal molecules are orthogonal to each other. The liquid crystal layer 104 is formed by a liquid crystal material such for example as a nematic liquid crystal. A state of alignment of the liquid crystal molecules in the liquid crystal layer 104 is changed according to the magnitude of a voltage applied through the sub-electrodes 102A and the electrode 105. Thereby transmittance control is performed.

Each of the polarizer 107A and the analyzer 107B selectively transmits polarized light in a direction along a predetermined axis of polarization, which polarized light is included in the incident light beam. In the present embodiment, as shown in FIG. 4, the polarizer 107A is divided into polarized light transmitting regions 107A1 to 107A4 in such a manner as to divide the plane shape of the polarizer 107A into four equal parts. An axis of polarization is formed in the polarized light transmitting regions 107A1 and 107A4 among the polarized light transmitting regions 107A1 to 107A4 so as to selectively transmit the first polarized light. An axis of polarization is formed in the polarized light transmitting regions 107A2 and 107A3 among the polarized light transmitting regions 107A1 to 107A4 so as to selectively transmit the second polarized light. The polarized light transmitting regions 107A1 to 107A4 are provided so as to correspond to the sub-electrodes 102A. It suffices for the analyzer 107B in the present embodiment to selectively transmit one of the first polarized light and the second polarized light, or for example the second polarized light, and the analyzer 107B in the present embodiment does not need to have different axes of polarization in the respective sub-regions 12L1, 12L2, 12R1, and 12R2.

Incidentally, the respective directions of polarization in the four polarized light transmitting regions of the polarizer 107A are not limited to the above-described combination. A polarizer 108A as shown in FIG. 5, for example, may also be used. Specifically, polarized light transmitting regions 108A1 and 108A3 corresponding to the sub-regions 12L1 and 12R1 may be made to selectively transmit the first polarized light, and polarized light transmitting regions 108A2 and 108A4 corresponding to the sub-regions 12L2 and 12R2 may be made to selectively transmit the second polarized light. That is, the region (12L) composed of the sub-regions 12L1 and 12L2 and the region (12R) composed of the sub-regions 12R1 and 12R2 may be bilaterally symmetric.

### (Action and Effect of First Embodiment)

### (Basic Operation of Imaging Device 1)

In the imaging device 1, a light beam of light from the imaging object 2 which light beam has passed through the imaging lens 11 is transmitted by a predetermined region of the liquid crystal shutter 12, and then reaches the imaging element 13. The imaging element 13 obtains imaging data Dout (parallax images DR and DL) based on the received light beam according to the driving operation of the imaging element driving section 15. An image processing section not shown in the figure subjects the parallax images DR and DL to predetermined image processing in the image processing section. Performed as the image processing are temporal rearrangement processing on the parallax images DR and DL, color interpolation processing such as demosaicing, and the like.

At this time, the liquid crystal shutter driving section 14 performs switching to open or close the regions 12L and 12R of the liquid crystal shutter 12 on a time division basis. Specifically, switching is performed such that the light beam directed to the imaging element 13 is transmitted in the region 12L of the liquid crystal shutter 12 and blocked in the region 12R of the liquid crystal shutter 12 in certain timing, and the light beam is blocked in the region 12L and transmitted in the region 12R in next timing. At this time, in the present embodiment, transmittance in each of the regions 12L and 12R is controlled according to the magnitude of the voltage supplied to each of the sub-electrodes 102A and the electrode 105. In this case, because the regions 12L and 12R are regions different from each other, the light beams transmitted by the respective regions 12L and 12R have a parallax with respect to each other. Thus, the switching operation of the liquid crystal shutter driving section 14 provides two parallax images DL and DR as if taken from two left and right viewpoints as imaging data Dout.

Liquid crystal shutters according to comparative examples (first and second comparative examples) will be described in the following with reference to FIGS. 6 to 9. FIG. 6 shows a sectional configuration of a liquid crystal shutter 110 according to the first comparative example and plane configurations of a polarizer, an electrode, and an analyzer in the liquid crystal shutter 110. FIG. 8 shows plane configurations of a polarizer, an electrode, and an analyzer according to the second comparative example.

### First Comparative Example

The liquid crystal shutter 110 has a liquid crystal layer 113 sealed in between a pair of substrates 111 and 115, has a polarizer 116A laminated to the side of the substrate 111, and has an analyzer 116B laminated to the side of the substrate 115. Electrodes 112 and 114 are formed between the substrates 111 and 115 and the liquid crystal layer 113. Of the electrodes, for example the electrode 112 formed on the side of the substrate 111 is divided into two sub-electrodes 112A in such a manner as to divide the electrode 112 into two left and right parts. The polarizer 116A and the analyzer 116B are each formed uniformly with an axis of polarization of each of the polarizer 116A and the analyzer 1162 along one direction, and the polarizer 116A and the analyzer 1162 are arranged such that the axes of polarization of the polarizer 116A and the analyzer 116B are orthogonal to each other. In the first comparative example, transmittance is controlled in each of a left region and a right region corresponding to the two sub-electrodes 112A, and thereby driving for switching between the opening and closing of these regions is performed.

### Second Comparative Example

Alternatively, as shown in FIG. 8, the directions of polarization of the two left and right regions may be different from each other. In this case, in a configuration similar to that of the liquid crystal shutter 110 according to the first comparative example, a polarizer 116 is divided into polarized light transmitting regions 116A1 and 116A2 transmitting respective pieces of polarized light that are orthogonal to each other. An electrode 112 is not divided, and an analyzer 116B is similar to that of the first comparative example.

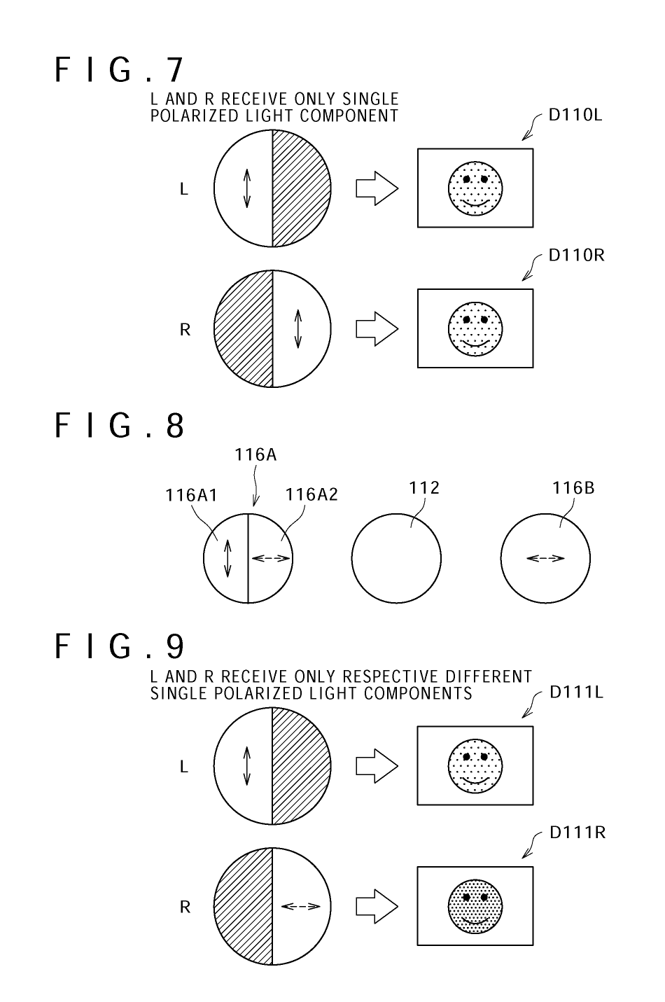

However, in the first and second comparative examples, when switching is performed between transmission and blockage in the two left and right regions, as shown in FIG. 7, imaging data dependent on polarized light is obtained because the direction of polarization of the polarizer 116A is uniform even if either of the left and right regions is opened. At this time, in the first comparative example, imaging data dependent on polarized light in an identical direction of polarization is obtained in each region. Thus, parallax images D110L and D110R are images as if observed via an identical polarizing filter, and are therefore unnatural images. In the second comparative example, as shown in FIG. 9, a left and a right parallax image D111L and D111R are images as if observed via respective polarizing filters having different directions of polarization, and are therefore more unnatural images than in the first comparative example. Incidentally, when an object is observed via a polarizing filter, an observed image is easily affected by light having great polarization dependence, for example light reflected on a water surface or light reflected on a glass surface, and thus becomes unnatural.

### (Characteristic Operation of Imaging Device 1)

On the other hand, in the present embodiment, the regions 12L and 12R in the liquid crystal shutter 12 are each divided into the sub-region (12L1 and 12R2) that selectively transmits the first polarized light and the sub-region (12L2 and 12R1) that selectively transmits the second polarized light. The region division into such sub-regions is realized by dividing the polarizer 107A into polarized light transmitting regions different from each other and performing individual driving based on electrode division (formation of four sub-electrodes 102A).

For example, when the liquid crystal shutter driving section 14 opens the region 12L according to the above-described switching operation, the liquid crystal shutter driving section 14 supplies a predetermined voltage to each of the sub-electrodes 102A and the electrode 105 in each of the sub-regions 12L1 and 12L2. Thereby, the liquid crystal shutter 12 is driven so as to make each of the light beams (the first polarized light and the second polarized light) transmitted by the polarized light transmitting regions 107A1 and 107A2 of the polarizer 107A pass through the liquid crystal layer 104 and the analyzer 107B. The same is true for a case of opening the region 12R. That is, the light beams received on the imaging element 13 through each of the regions 12L and 12R are each based on both the first polarized light and the second polarized light. Thus, the two parallax images DL and DR obtained are reduced in polarization dependence as compared with the parallax images dependent on only one piece of polarized light as in the first and second comparative examples. Thus, natural parallax images not easily affected by light having great polarization dependence are obtained. When an image of a fish or the like in a water is imaged through the water surface, for example, a polarized light component different from reflected light from the water surface can be detected. Thereby a natural observed image of a state in the water can be obtained with the reflected light component removed.

As described above, in the present embodiment, the light beam directed to the imaging element 13 is changed and transmitted by each of the left and right regions 12L and 12R of the liquid crystal shutter 12, so that two left and right parallax images can be obtained. In addition, because the regions 12L and 12R are each divided into sub-regions that transmit the first polarized light and the second polarized light, respectively, imaging data can be obtained on the basis of both the first polarized light and the second polarized light. Hence, natural parallax images with reduced limitation of polarization can be obtained.

### (Example of Application)

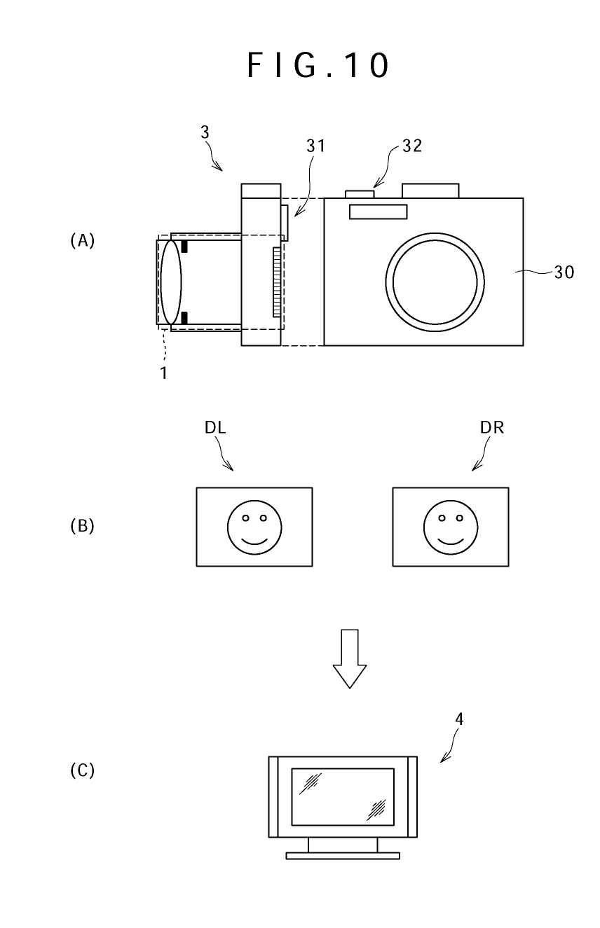

Such an imaging device 1 is used in a state of being mounted in a camera 3 as shown in FIG. 10(A), for example. The camera 3 includes the imaging device 1 inside a casing 30, and has mechanisms of a finder 31, a shutter button 32, and the like. In addition, two parallax images DL and DR (FIG. 10(3)) taken by the camera 3 are displayed as an image for a right eye and an image for a left eye by using a 3D display device 4 for three-dimensional display as shown in FIG. 10(C), for example. A stereoscopy can be realized by observing the displayed image for a right eye by a right eye and the displayed image for a left eye by a left eye separately.

### Second Embodiment

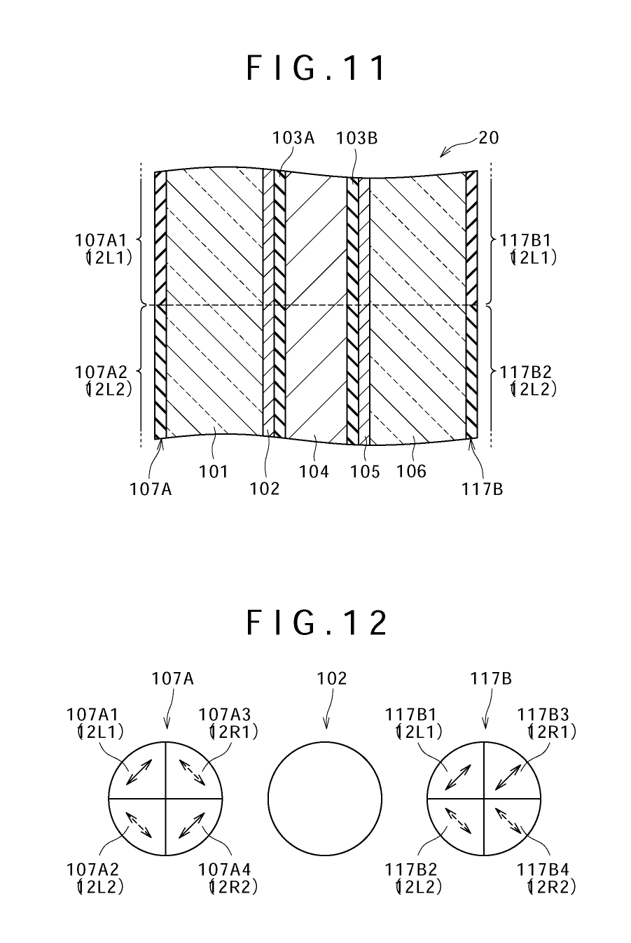

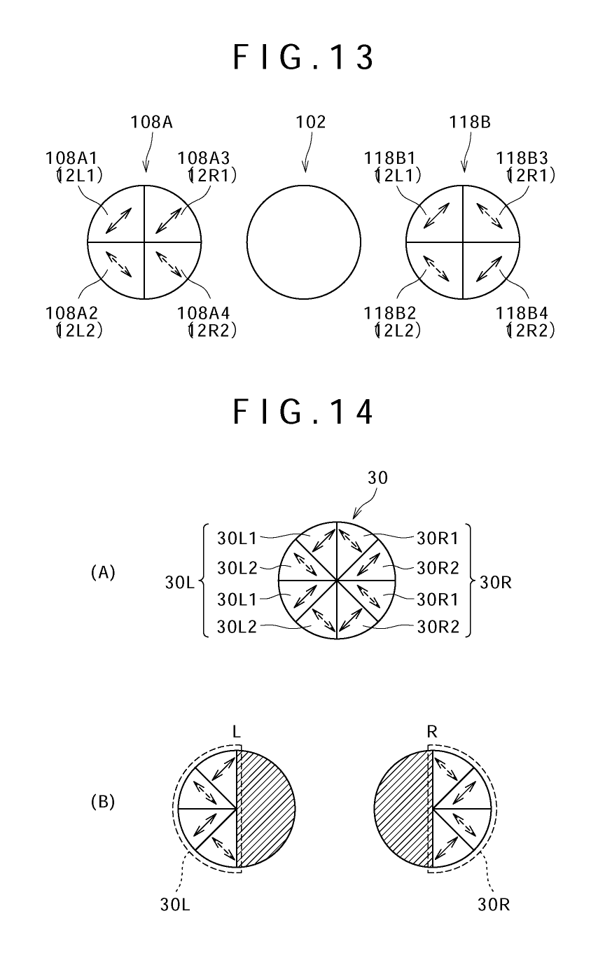

FIG. 11 shows a sectional configuration of a liquid crystal shutter (liquid crystal shutter 20) according to a second embodiment of the present invention. FIG. 12 schematically shows respective plane configurations of a polarizer, an electrode, and an analyzer. FIG. 13 shows another example of plane configuration of a polarizer and an analyzer.

### (Configuration of Liquid Crystal Shutter 20)

As with the liquid crystal shutter 12 according to the foregoing first embodiment, the liquid crystal shutter 20 is provided to control the transmittance of a light beam directed to an imaging element 13 according to the driving of a liquid crystal shutter driving section 14 in an imaging device 1. In addition, as with the liquid crystal shutter 12 according to the foregoing first embodiment, the liquid crystal shutter 20 has two left and right regions 12L and 12R that can perform transmittance controls different from each other. Further, the regions 12L and 12R are divided into sub-regions 12L1, 12L2, 12R1, and 12R2 that respectively transmit first polarized light and second polarized light. However, in the present embodiment, region division in such a liquid crystal shutter 20 is performed by division into polarized light transmitting regions in the polarizer and the analyzer. In the following, similar constituent elements to those of the foregoing first embodiment are identified by the same reference symbols, and description thereof will be omitted as appropriate.

Specifically, the liquid crystal shutter 20 is formed by sealing in a liquid crystal layer 104 between substrates 101 and 106, and laminating a polarizer 107A to the side of the substrate 101 and laminating an analyzer 117B (second polarizer) to the side of the substrate 106. Electrodes 102 and 105 and alignment films 103A and 103B are respectively formed between the substrates 101 and 106 and the liquid crystal layer 104.

In the present embodiment, unlike the foregoing first embodiment, the electrode 102 does not need to be divided into sub-electrodes. The analyzer 117B selectively transmits polarized light in a direction along a predetermined axis of polarization, which polarized light is included in an incident light beam. However, the analyzer 117B in this case is divided into polarized light transmitting regions 117B1 to 117B4 so as to correspond to the polarized light transmitting regions 107A1 to 107A4 of the polarizer 107A. An axis of polarization is formed in the polarized light transmitting regions 117B1 and 117B3 among the polarized light transmitting regions 117B1 to 117B4 so as to selectively transmit the first polarized light. An axis of polarization is formed in the polarized light transmitting regions 117B2 and 117B4 among the polarized light transmitting regions 117B1 to 117B4 so as to selectively transmit the second polarized light. That is, in the present embodiment, transmittance control in each of the regions 12L and 12R is made possible by a combination of the polarizer 107A and the analyzer 117B.

Incidentally, the combination of respective directions of polarization of the four polarized light transmitting regions of the polarizer 107A and the four polarized light transmitting regions of the analyzer 117B is not limited to the above-described configuration. A polarizer 108A and an analyzer 118B as shown in FIG. 13, for example, may also be used. In this case, in the polarizer 108A, polarized light transmitting regions 108A1 and 108A3 corresponding to sub-regions 12L1 and 12R1 are made to selectively transmit the first polarized light, and polarized light transmitting regions 108A2 and 108A4 corresponding to sub-regions 12L2 and 12R2 are made to selectively transmit the second polarized light. That is, a region (12L) composed of the sub-regions 12L1 and 12L2 and a region (12R) composed of the sub-regions 12R1 and 12R2 may be bilaterally symmetric. As for the analyzer 118B, polarized light transmitting regions 118B1 and 118B4 corresponding to the sub-regions 12L1 and 12R2 are made to selectively transmit the first polarized light, and polarized light transmitting regions 118B2 and 11833 corresponding to the sub-regions 12L2 and 12R1 are made to selectively transmit the second polarized light.

### (Action and Effect of Second Embodiment)

Also in the present embodiment, as in the foregoing first embodiment, switching is performed to open and close the regions 12L and 12R of the liquid crystal shutter 20 by the driving operation of the liquid crystal shutter driving section 14. The imaging element 13 thereby obtains imaging data Dout (DR and DL) based on a received light beam in each of the regions 12L and 12R.

In this case, in the liquid crystal shutter 20, the analyzer 1173 is divided into the polarized light transmitting regions 117B1 to 117B4 so as to correspond to the polarized light transmitting regions 107A1 to 107A4 of the polarizer 107A. In such a configuration, the liquid crystal shutter driving section 14 performs switching to open and close the regions 12L and 12R of the liquid crystal shutter 20 according to the magnitude of a voltage supplied to the electrodes 102 and 105. For example, when the region 12L is opened, the voltage is supplied so as to make the light beam (the first polarized light and the second polarized light) transmitted by the polarized light transmitting regions 107A1 and 107A2 of the polarizer 107A pass through the liquid crystal layer 104 and the polarized light transmitting regions 117B1 and 117B2 of the analyzer 117B.

Thus, as in the liquid crystal shutter 12 according to the foregoing first embodiment, the received light beams in each of the regions 12L and 12R are each based on both the first polarized light and the second polarized light. Hence, equal effects to those of the foregoing first embodiment can be obtained.

Examples of modification (a first to a third example of modification) of the liquid crystal shutters according to the foregoing first and second embodiments will next be described. In the following, similar constituent elements to those of the foregoing first embodiment are identified by the same reference symbols, and description thereof will be omitted as appropriate.

### First Example of Modification

FIGS. 14(A) and 14(B) schematically show region division and directions of polarization (solid line arrows and dotted line arrows) of a liquid crystal shutter 30 according to the first example of modification. The present example of modification is an example of region division of a liquid crystal shutter. The region division in the present example of modification is applicable to both of the foregoing first embodiment (electrode division) and the foregoing second embodiment (region division of an analyzer).

As in the case of the regions 12L and 12R of the foregoing first embodiment, the liquid crystal shutter 30 has two left and right regions 30L and 30R that can perform transmittance controls different from each other. In addition, the regions 30L and 30R are radially divided into equal sub-regions (sub-regions 30L1, 30L2, 30R1, and 30R2) that respectively transmit first polarized light and second polarized light. An axis of polarization is formed in the sub-regions 30L1 and 30R2 among these sub-regions so as to selectively transmit the first polarized light. An axis of polarization is formed in the sub-regions 30L2 and 30R1 so as to selectively transmit the second polarized light. In FIG. 14(B), hatched parts indicate that a light beam is blocked (close). That is, the region 30L is open on the left (L) of the figure, and the region 30R is open on the right (R) of the figure.

However, in the present example of modification, these sub-regions 30L1, 30L2, 30R1, and 30R2 are each provided plurally in each of the regions 30L and 30R. Specifically, two sub-regions 30L1 and two sub-regions 30L2 are provided in the region 30L, and the sub-regions 30L1 and the sub-regions 30L2 are arranged alternately. Also in the region 30R, two sub-regions 30R1 and two sub-regions 30R2 are provided, and the sub-regions 30R1 and the sub-regions 30R2 are arranged alternately. That is, each of the regions 30L and 30R is divided into four equal sub-regions, and the liquid crystal shutter 30 as a whole is divided into eight equal sub-regions.

Thus, the sub-regions 30L1, 30L2, 30R1, and 30R2 respectively dividing the regions 30L and 30R in the liquid crystal shutter 30 may be each provided plurally. That is, the number of divisions of the regions 30L and 30R is not particularly limited, but may be two as in the foregoing first and second embodiments or may be four as in the present example of modification. This is because equal effects to those of the foregoing first embodiment can be obtained when regions respectively transmitting the first polarized light and the second polarized light are included. In addition, polarization dependence can be further reduced by increasing the number of divisions of each of the regions 30L and 30R and alternately arranging the sub-regions 30L1 and 30R2 transmitting the first polarized light and the sub-regions 30L2 and 30R1 transmitting the second polarized light. Thus, more natural parallax images than in the foregoing first and second embodiments can be obtained.

### Second Example of Modification

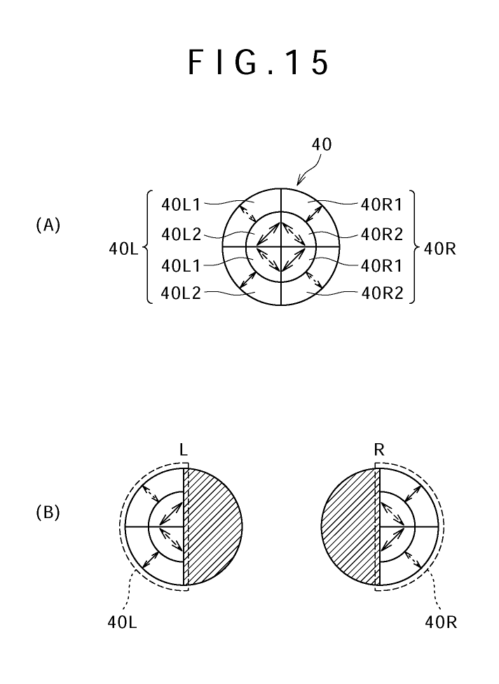

FIGS. 15(A) and 15(B) schematically show region division and directions of polarization (solid line arrows and dotted line arrows) of a liquid crystal shutter 40 according to the second example of modification. The present example of modification is an example of region division of a liquid crystal shutter. The region division in the present example of modification is applicable to both of the foregoing first embodiment (electrode division) and the foregoing second embodiment (region division of an analyzer).

As in the case of the regions 12L and 12R of the foregoing first embodiment, the liquid crystal shutter 40 has two left and right regions 40L and 40R that can perform transmittance controls different from each other. In addition, the regions 40L and 40R are divided into sub-regions (sub-regions 40L1, 40L2, 40R1, and 40R2) that respectively transmit first polarized light and second polarized light. An axis of polarization is formed in the sub-regions 40L2 and 40R1 among these sub-regions so as to selectively transmit the first polarized light. An axis of polarization is formed in the sub-regions 40L1 and 40R2 so as to selectively transmit the second polarized light. In the present example of modification, as in the foregoing first example of modification, these sub-regions 40L1, 40L2, 40R1, and 40R2 are each provided plurally (specifically two each) in each of the regions 40L and 40R. In FIG. 15(B), hatched parts indicate that a light beam is blocked. That is, the region 40L is open on the left (L) of the figure, and the region 40R is open on the right (R) of the figure.

However, in the present example of modification, the liquid crystal shutter 40 is divided into regions such that the plane shape (circle) of the liquid crystal shutter 40 is radially divided into four equal parts and concentrically divided into two equal parts. That is, the liquid crystal shutter 40 is divided along a θ-direction and an arc R-direction in the circle of the liquid crystal shutter 40. In the region 40L, the sub-regions 40L1 and the sub-regions 40L2 are arranged alternately (so as not to be adjacent to each other). Also in the region 40R, the sub-regions 40R1 and the sub-regions 40R2 are arranged alternately. That is, each of the regions 40L and 40R is divided into four equal sub-regions, and the liquid crystal shutter 40 as a whole is divided into eight equal sub-regions.

Thus, the divided shapes of the sub-regions 40L1, 40L2, 40R1, and 40R2 in the regions 40L and 40R of the liquid crystal shutter 40 are not limited to radial shapes as described above, but may be concentric shapes. Alternatively, the radial shapes and the concentric shapes may be combined with each other. Equal effects to those of the first embodiment and the first example of modification described above can be obtained also in this case.

### Third Embodiment

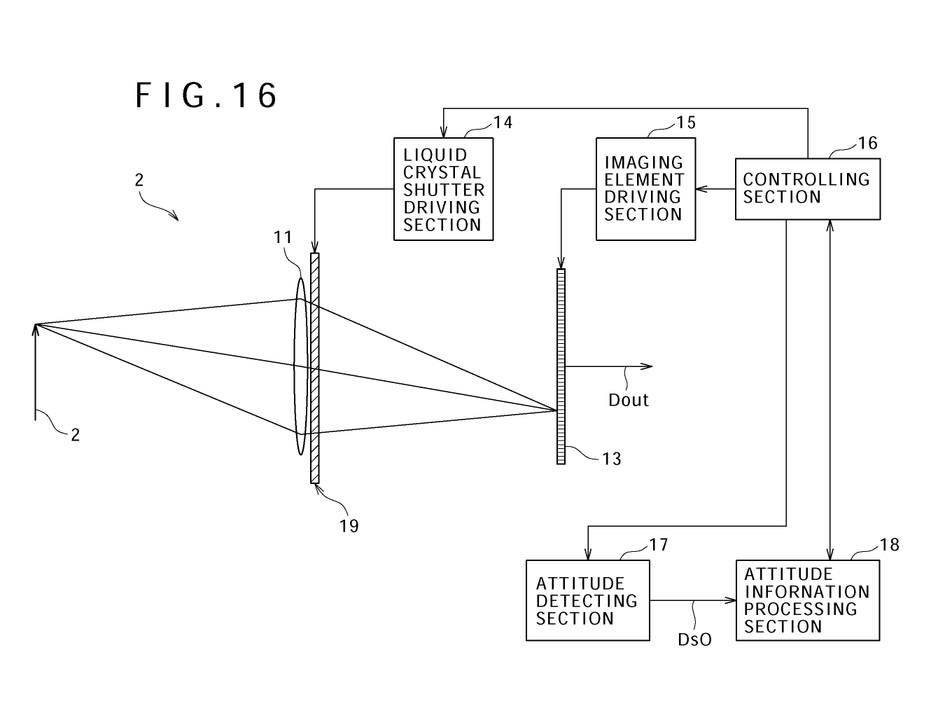

FIG. 16 shows a general constitution of an imaging device according to a third embodiment of the present invention (imaging device 2). As with the imaging device 1 according to the first embodiment, the imaging device 2 picks up an image of an imaging object 2, and outputs imaging data Dout. The imaging device 2 includes an imaging lens 11, a liquid crystal shutter 19 (liquid crystal shutter), an imaging element 13, a liquid crystal shutter driving section 14, an imaging element driving section 15, and a controlling section 16. In the present embodiment, however, an attitude detecting section 17 and an attitude information processing section 18 are further provided, and the liquid crystal shutter driving section 14 drives the liquid crystal shutter 19 according to the attitude of the imaging device 2 (specifically the attitude of a camera 3 or the casing thereof). In addition, description will be made supposing that the imaging device 2 is housed in a casing not shown in the figure, and for example functions as the above-described camera 3 or the like. Incidentally, suppose that the “attitude” in this case refers to a state of inclination (rotational state) of the imaging device 2 in a plane parallel to the light receiving surface of the imaging element. In the following, constituent elements similar to those of the foregoing first embodiment are identified by the same reference numerals, and description thereof will be omitted as appropriate.

### (Constitution of Liquid Crystal Shutter 19)

As with the liquid crystal shutter 12 according to the foregoing first embodiment, the liquid crystal shutter 19 is provided to control the transmittance of a light beam going toward the imaging element 13 according to the driving of the liquid crystal shutter driving section 14 in the imaging device 1. In addition, the liquid crystal shutter 19 has a plurality of regions (four regions in this case) (regions corresponding to regions a1 to a4 to be described later) capable of transmittance controls different from each other as a result of electrode division.

In the present embodiment, however, region division in a polarizer as described in the foregoing first embodiment is not essential, and the polarizer may be divided into regions, or may not be divided into regions. Description in the following will be made by taking as an example a case where the polarizer is not divided into regions (case where the polarizer each transmits only polarized light in one direction) for simplicity.

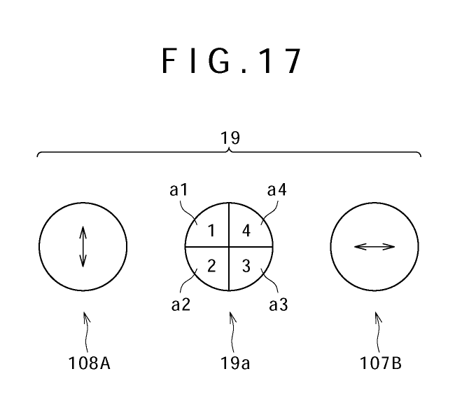

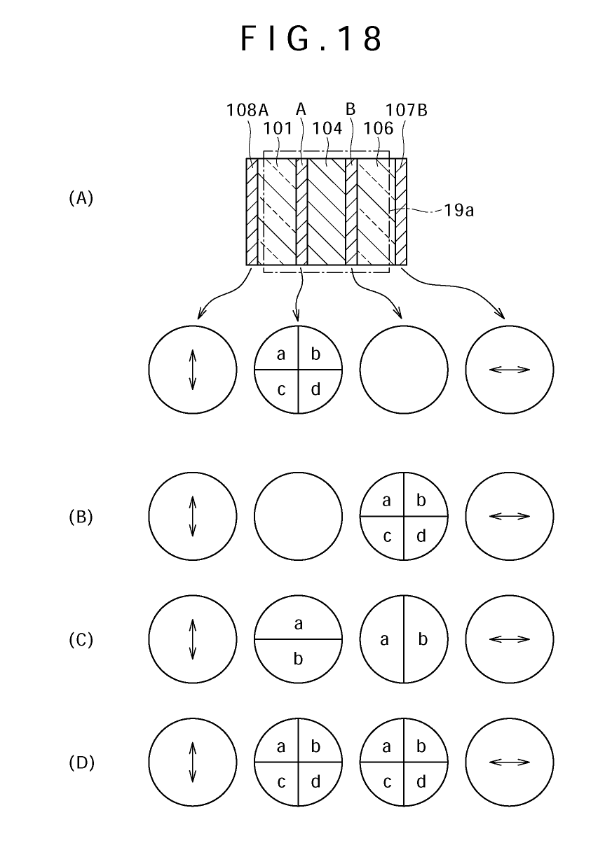

For example, as shown in FIG. 17, the liquid crystal shutter 19 has a four-part split liquid crystal 19a divided into four radial regions a1 to a4 (identified by numbers “1” to “4” for convenience in this case) between a polarizer 108A and an analyzer 107B. The polarizer 108A selectively transmits polarized light in one direction (for example a 90° direction or a 0° direction). The analyzer 1073 selectively transmits polarized light in a direction orthogonal to the polarizer 108A (for example the 0° direction or the 90° direction).

### (Example of Electrode Division Patterns)

FIGS. 18(A) to 18(D) show a sectional constitution of the liquid crystal shutter 19 and an example of electrode division patterns. Thus, the four-part split liquid crystal 19a is formed by sealing a liquid crystal layer 104 via electrodes A and B between substrates 101 and 106. As with the electrodes 102 and 105 in the foregoing first embodiment, the electrodes A and B are to apply a voltage to the liquid crystal layer 104. The liquid crystal shutter 19 (four-part split liquid crystal 19a) is divided into the four regions a1 to a4 as described above according to a division pattern of these electrodes A and B.

In an electrode division pattern, as shown in FIGS. 18(A) and 18(B), for example, only one of the electrodes A and B is divided into four sub-electrodes a to d, and the other electrode is formed as a solid electrode (undivided electrode). In these cases, the four sub-electrodes a to d in one electrode correspond to the regions a1 to a4 in the four-part split liquid crystal 19a. Such an electrode division pattern facilitates alignment between the electrodes A and B.

Alternatively, as shown in FIG. 18(C), the electrodes A and B may each be divided into two sub-electrodes a and b, and the sub-electrodes a and b in the electrode A may be arranged so as to be shifted from the sub-electrodes a and b in the electrode B by a predetermined angle (for example 90°). In other words, the electrodes A and B may be arranged such that directions of division of the respective electrodes A and B are orthogonal to each other. In this case, the sub-electrodes a and b of one of the electrodes A and B are individually supplied with voltage (are set as individually driven electrodes), and the sub-electrodes a and b in the other electrode are supplied with a mutually same voltage (are set as a common electrode). Which of these electrodes A and B is set as individually driven electrodes or a common electrode is determined according to a required visual point direction. For example, when shutter switching is performed in a left-to-right direction (a left visual point image and a right visual point image are to be obtained), it suffices to perform electrode driving as follows. That is, the electrode B is made to function as individually driven electrodes, and the electrode A is made to function as a common electrode. The sub-electrodes a and b of the electrode A are supplied with a mutually same common voltage (for example maintained at a ground potential). The sub-electrodes a and b of the electrode B are alternately supplied with voltage on a time division basis. Thereby, regions respectively corresponding to the sub-electrodes a and b of the electrode B can be selected as unit regions to be described later. When such an electrode division pattern is used, the electrodes A and B can be formed by a same electrode pattern, and can therefore be formed on a same manufacturing line.

In addition, as shown in FIG. 18(D), the electrodes A and B may each be divided into four sub-electrodes a to d, and the sub-electrodes in the electrode A and the sub-electrodes in the electrode B may be opposed to each other (face each other). When such an electrode division pattern is used, the four regions a1 to a4 can be subjected to voltage control completely independently of each other. Thus, the value of applied voltage can be reduced by performing voltage control of a so-called common inversion system.

### (Attitude Detecting Section 17 and Attitude Information Processing Section 18)

The attitude detecting section 17 has a function of detecting the attitude of the whole of the imaging device 2, specifically the attitude of a casing in which the imaging device 2 is housed (which casing is the casing 30 of the camera 3 shown in FIG. 10, for example, and will hereinafter be described as a “casing 30”) (specifically a function of measuring information on the attitude). For example a sensor capable of detecting an angular velocity, an angular acceleration or the like, such as a gyro sensor or the like, is cited as the attitude detecting section 17. By thus incorporating the attitude detecting section 17 into the imaging device 2, for example, information (information DsO to be described later) on the attitude of the casing 30 can be obtained.

The attitude information processing section 18 subjects the attitude information detected by the attitude information detecting section 17 to predetermined processing, and outputs the attitude information after the processing to the controlling section 16. Specifically, the attitude information processing section 18 obtains the angle of inclination (angle of rotation) or the like of the casing 30, and detects (determines) the attitude of the casing 30, on the basis of the information on the attitude detected (measured) in the attitude detecting section 17.

### [Action and Effect of Third Embodiment]

Also in the present embodiment, as in the foregoing first embodiment, the liquid crystal shutter driving section 14 switches between the opening and the closing of each region of the liquid crystal shutter 19 as described above, whereby the imaging element 13 obtains imaging data Dout based on a received light beam in each region.

### (Shutter Switching Operation Based on Attitude Information)

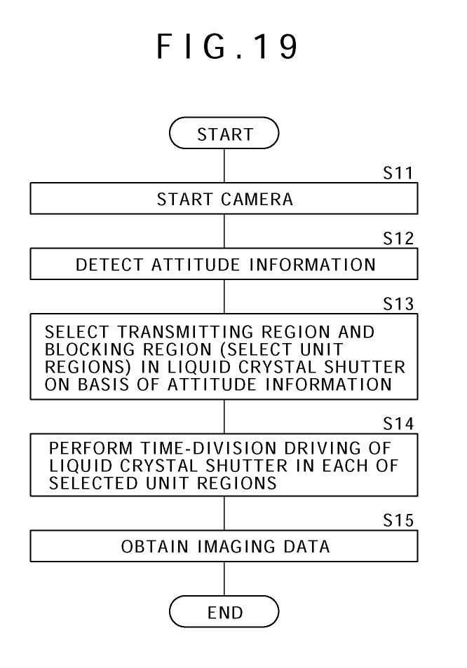

However, in the present embodiment, shutter switching operation is performed according to the attitude of the casing 30 as follows, and imaging data Dout is obtained. FIG. 19 shows a flow of a process up to the obtainment of imaging data in the present embodiment. Thus, the camera 3 as the imaging device 2 is started (step S11). Thereafter, information on the attitude of the casing 30 is detected first (step S12). Specifically, the attitude detecting section 17 measures information DsO on the attitude of the casing 30 (information such as an angular velocity or the like), and then outputs the information DsO to the attitude information processing section 18. The attitude information processing section 18 obtains the angle of inclination (angle of rotation) or the like of the casing 30 on the basis of the input information DsO, and outputs the angle of inclination (angle of rotation) or the like of the casing 30 as attitude information Ds to the controlling section 16.

Next, the controlling section 16 outputs a predetermined control signal to the liquid crystal shutter driving section 14 together with the attitude information Ds supplied as described above. The liquid crystal shutter driving section 14 drives the liquid crystal shutter 19 according to the attitude information Ds and the control signal. Specifically, the liquid crystal shutter driving section 14 selects (sets) unit regions 19L and 19R to be opened and closed as an opened region (transmitting region) and a closed region (blocking region) in the liquid crystal shutter 19 on the basis of the attitude information Ds (step S13).

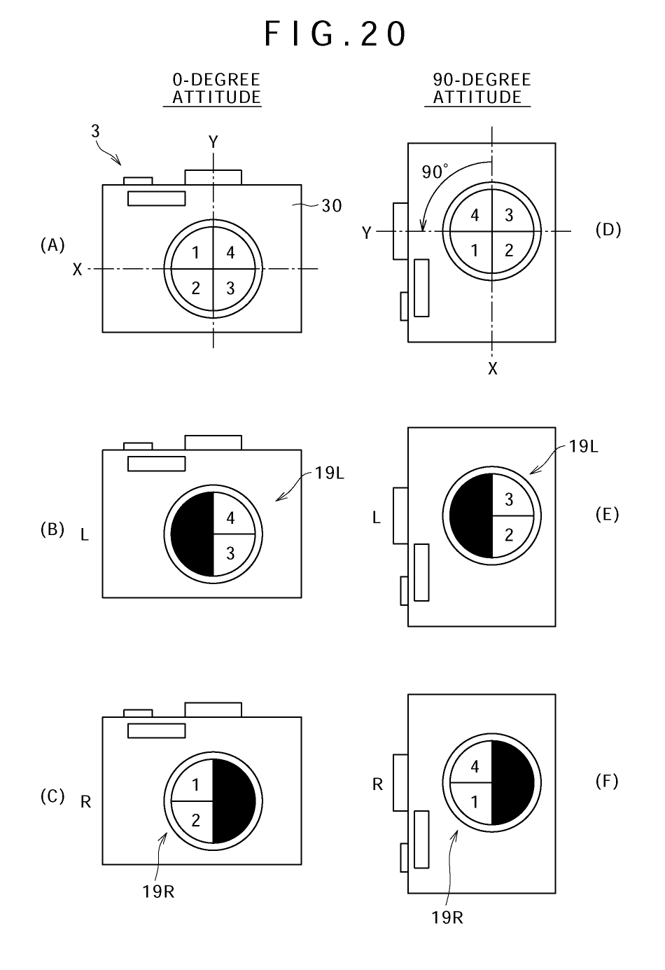

A concrete shutter switching operation will be described in the following with reference to FIGS. 20(A) to 20(F). FIG. 20(A) schematically represents a case where the camera 3 (casing 30) is in a reference attitude (0° attitude). The axis of abscissas of the casing 30 (X-axis) coincides with a horizontal direction. The axis of ordinates of the casing 30 (Y-axis) coincides with a vertical direction. In the case of such a 0° attitude (case where the attitude information Ds indicates the 0° attitude), the liquid crystal shutter driving section 14 selects unit regions 19L and 19R corresponding to desired visual point directions among the four regions a1 to a4 (“1” to “4,” which numbers will be used for description in the following) of the liquid crystal shutter 19. For example, when a left visual point image and a right visual point image are to be obtained, the liquid crystal shutter driving section 14 selects “3” and “4” as the unit regions 19L, and selects “1” and “2” as the unit regions 19R, as shown in FIGS. 20(B) and 20(C).

On the other hand, FIG. 20(D) schematically represents a case where the camera 3 (casing 30) is in a 90° attitude. The X-axis and the Y-axis of the casing 30 are inclined (rotated) by 90° from the 0° attitude. In the case of such a 90° attitude (case where the attitude information Ds indicates the 90° attitude), the liquid crystal shutter driving section 14 selects unit regions 19L and 19R corresponding to desired visual point directions among the four regions “1” to “4” of the liquid crystal shutter 19. For example, when a left visual point image and a right visual point image are to be obtained, the liquid crystal shutter driving section 14 selects “2” and “3” as the unit regions 19L, and selects “4” and “1” as the unit regions 19R, as shown in FIGS. 20(E) and 20(F).

The liquid crystal shutter driving section 14 thereafter performs time division driving of the liquid crystal shutter 19 such that switching between the opened state and the closed state is performed in each of the unit regions 19L and 19R selected as described above (step S14). The imaging element 13 thereby obtains imaging data Dout for desired visual point images (for example a left visual point image and a right visual point image) in either of the case of the 0° attitude and the case of the 90° attitude (step S15). The imaging data obtaining process is thereby ended.

As described above, in the present embodiment, the liquid crystal shutter 19 is divided into the four regions a1 to a4, the liquid crystal shutter driving section 14 selects appropriate regions (unit regions 19L and 19R) corresponding to a left visual point direction and a right visual point direction from the four regions a1 to a4 in each of the case where the casing 30 is in the 0° attitude and the case where the casing 30 is in the 90° attitude, and the liquid crystal shutter driving section 14 switches between the opening and the closing of these regions. That is, a left visual point image and a right visual point image can be obtained in not only the case where the casing 30 is in the reference attitude (0° attitude) but also the case where the casing 30 is in such an attitude as to be inclined 90°, for example. This is useful particularly in cases where the imaging device 2 is applied to still cameras and the like that often take photographs in the 90° attitude. Hence, desired visual point images can be obtained without the attitude at the time of photographing limited to one direction.

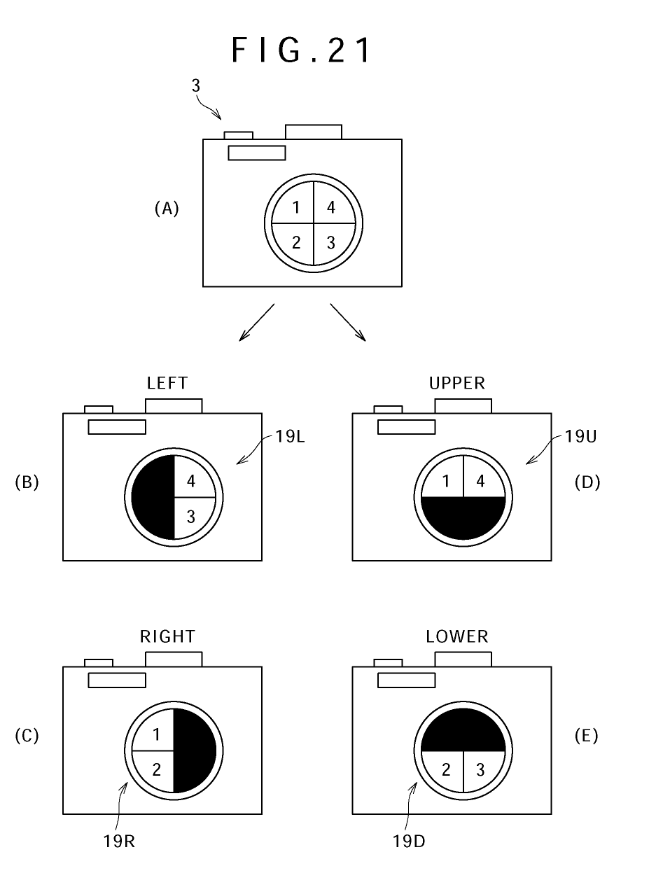

Incidentally, in the foregoing third embodiment, a case where regions corresponding to the respective left and right visual point directions are selected as the unit regions 19L and 19R and switching between the opened state and the closed state is performed in the two left and right regions has been cited as an example. However, regions may be made to correspond to not only the left and right directions but also an upper visual point direction and a lower visual point direction (unit regions 19U and 19D in FIGS. 21(A) to 21(E)).

In addition, description has been made by taking as an example a case where a polarizer without polarization divisions is used as the polarizer 108A. However, the polarizer 107A divided into polarization divisions as described in the foregoing first embodiment may be used. This provides not only an effect of reducing attitude limitation in the foregoing third embodiment but also an effect of eliminating polarization limitation in the above-described first embodiment, and is thus more desirable.

### Third Example of Modification

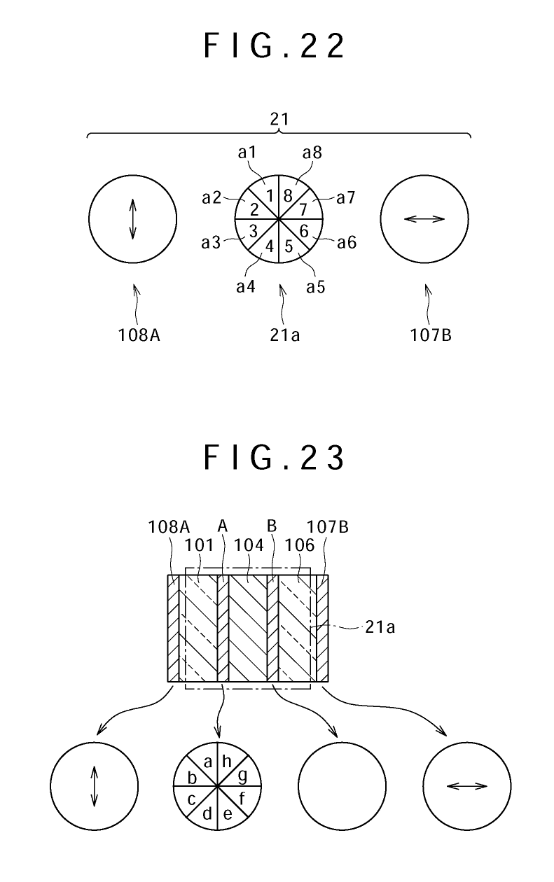

FIG. 22 shows a schematic constitution of a liquid crystal shutter (liquid crystal shutter 21) according to an example of modification of the foregoing third embodiment (third example of modification). The liquid crystal shutter 21 controls the transmittance of a light beam going toward the imaging element 13 in the imaging device 1, as with the liquid crystal shutter 12 described above. In addition, the liquid crystal shutter 21 has a plurality of regions capable of transmittance controls different from each other as a result of electrode division, as with the four-part split liquid crystal shutter 19 described above. The liquid crystal shutter 21 is suitably used particularly in the imaging device 2 having the attitude detecting mechanism in the foregoing third embodiment.

In the present example of modification, however, the liquid crystal shutter 21 is divided into eight regions a1 to a8. Specifically, the liquid crystal shutter 21 has an eight-part split liquid crystal 21a divided into eight regions a1 to a8 between a polarizer 108A and an analyzer 107B. As shown in FIG. 23, the eight-part split liquid crystal 21a is formed by sealing a liquid crystal layer 104 via electrodes A and B between substrates 101 and 106. One or both of the electrodes A and B are divided into a predetermined electrode pattern. In this case, only the electrode A is divided into eight sub-electrodes a to h, and the electrode B is a solid electrode. However, as in the foregoing third embodiment, only the electrode B may be divided into eight parts, or both of the electrodes A and B may be divided into eight parts. Alternatively, both of the electrodes A and B may be divided into four parts, and the respective sub-electrodes in the electrodes A and B may be arranged so as to be shifted from each other by a predetermined angle.

Such a liquid crystal shutter 21 is used in the imaging device 2 described above. Thereby, as in the foregoing third embodiment, shutter switching is performed according to the attitude of the casing 30 (on the basis of the attitude information Ds), and imaging data Dout for visual point images is obtained. In the present example of modification, however, unit regions 21L and 21R to be opened and closed in the liquid crystal shutter 21 can be selected (set) according to three attitudes (0°, 90°, and 45°) of the casing 30, for example.

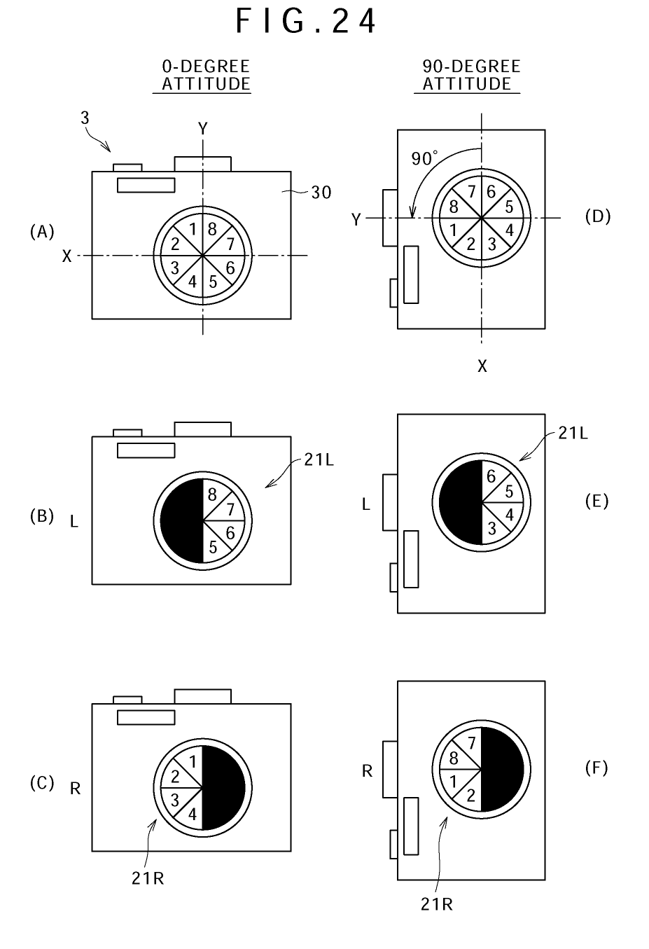

FIG. 24(A) schematically represents a case where the camera 3 (casing 30) is in a reference attitude (0° attitude). In the case of such a 0° attitude (case where the attitude information Ds indicates the 0° attitude), the liquid crystal shutter driving section 14 selects unit regions 21L and 21R corresponding to desired visual point directions among the eight regions a1 to a8 (“1” to “8,” which numbers will be used for description in the following) of the liquid crystal shutter 21. For example, when a left visual point image and a right visual point image are to be obtained, the liquid crystal shutter driving section 14 selects “5” to “8” as the unit regions 21L, and selects “1” to “4” as the unit regions 21R, as shown in FIGS. 24(B) and 24(C).

FIG. 24(D) schematically represents a case where the camera 3 (casing 30) is in a 90° attitude. In the case of such a 90° attitude (case where the attitude information Ds indicates the 90° attitude), the liquid crystal shutter driving section 14 selects unit regions 21L and 21R corresponding to desired visual point directions among the eight regions “1” to “8” of the liquid crystal shutter 21. For example, when a left visual point image and a right visual point image are to be obtained, the liquid crystal shutter driving section 14 selects “3” to “6” as the unit regions 21L, and selects “7,” “8,” “1,” and “2” as the unit regions 19R, as shown in FIGS. 24(E) and 24(F).

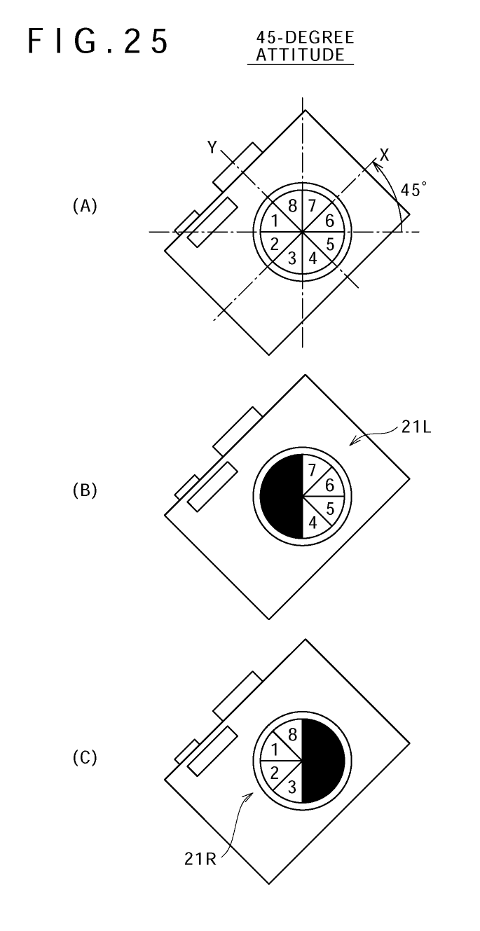

FIG. 25(A) schematically represents a case where the camera 3 (casing 30) is in a 45° attitude. The X-axis and the Y-axis of the casing 30 are inclined (rotated) by 45° from the 0° attitude. In the case of such a 45° attitude (case where the attitude information Ds indicates the 45° attitude), the liquid crystal shutter driving section 14 selects unit regions 21L and 21R corresponding to desired visual point directions among the eight regions “1” to “8” of the liquid crystal shutter 21. For example, when a left visual point image and a right visual point image are to be obtained, the liquid crystal shutter driving section 14 selects “4” to “7” as the unit regions 21L, and selects “8,” “1,” “2,” and “3” as the unit regions 21R, as shown in FIGS. 25(B) and 25(C).

As described above, in the present embodiment, the liquid crystal shutter 21 is divided into the eight regions a1 to a8, the liquid crystal shutter driving section 14 selects appropriate regions (unit regions 21L and 21R) corresponding to a left visual point direction and a right visual point direction from the eight regions a1 to a8 in each of the case where the camera 3 (casing 30) is in the 0° attitude, the case where the camera 3 (casing 30) is in the 90° attitude, and the case where the camera 3 (casing 30) is in the 45° attitude, and the liquid crystal shutter driving section 14 switches between the opening and the closing of these regions. That is, a left visual point image and a right visual point image can be obtained in not only the case where the casing 30 is in the 0° attitude as the reference attitude but also the case where the casing 30 is in such an attitude as to be inclined 90° or 45°, for example. Hence, desired visual point images can be obtained without the attitude at the time of photographing limited to one direction. In addition, by increasing the number of divisions of the liquid crystal shutter 21 as in the present example of modification, visual point images in desired visual point directions can be obtained in more attitudes such as not only the 0° attitude and the 90° attitude but also the 45° attitude and the like.

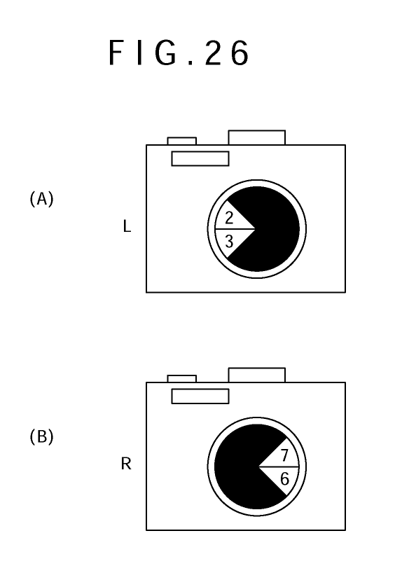

Incidentally, while four regions corresponding to one half on one side of the liquid crystal shutter 21 may be selected as the unit regions 21L or 21R to be opened or closed as described above, less than four regions (less than half the number of divisions) may be selected as unit regions, as shown in FIGS. 26(A) and 26(B).

The present invention has been described above by citing embodiments and examples of modification. However, the present invention is not limited to these embodiments and the like, but is susceptible of various modifications. For example, in the foregoing embodiments and the like, description has been made by taking as an example a case where sub-regions are formed by dividing two left and right regions in a liquid crystal shutter into equal parts radially or concentrically. However, the divided shapes of the sub-regions are not limited to these. For example, each region may be divided into sub-regions in the form of a lattice (in the form of a matrix), and sub-regions transmitting first polarized light and sub-regions transmitting second polarized light may be formed alternately (for example in a checkered form). In addition, the regions do not necessarily need to be “divided into equal parts.” Equal effects to those of the present embodiment can be obtained as long as each region has sub-regions that respectively transmit first polarized light and second polarized light. Further, the number of divisions is not particularly limited. The larger the number, the more easily polarization dependence is reduced. However, when the number of divisions is increased, region division is desirably performed by the electrode division described in the foregoing first embodiment. Subdivision can be performed by using various kinds of lithography or the like. On the other hand, it is difficult to increase the number of divisions of a polarizer and an analyzer from a viewpoint of processes. Thus, from the viewpoint of processes, a small number of divisions is desirable. A minimum number of divisions is four (two on each of the left and the right).

In addition, the directions of polarization in the respective polarized light transmitting regions in the polarizer and the analyzer in the foregoing embodiments and the like are not limited to the directions of polarization described above; various combinations can be set according to a liquid crystal layer driving mode or the like. In addition, while the first polarized light and the second polarized light have been described as pieces of polarized light whose directions of polarization are orthogonal to each other, the directions of polarization do not necessarily need to be orthogonal to each other.

Further, in the foregoing embodiments and the like, a case of dividing each region of a liquid crystal shutter into two kinds of sub-regions that respectively transmit the first polarized light and the second polarized light has been taken as an example. However, sub-regions may include another sub-region that selectively transmits another polarized light component.

In addition, the visual point images obtained in the imaging devices described in the foregoing embodiments and the like may be still images or moving images. In the case of moving images, it suffices for the liquid crystal shutter to be driven such that switching between the opened state and the closed state in each of the unit regions of the shutter is alternately performed on a time division basis.

Further, while an example in which one electrode 102 of the pair of electrodes 102 and 105 in the liquid crystal shutter 12 is divided into a plurality of sub-electrodes is cited as a method of electrode division in the foregoing embodiments, the electrode 105 on the opposite side may be divided, or both electrodes may be divided.

In addition, the foregoing embodiments have been described by taking as an example a case where switching between opening and closing is performed in two regions in a liquid crystal shutter. However, the number of regions in which the switching is performed is not limited to two, but may be three or more. In this case, the plane shape of the liquid crystal shutter is desirably divided into a radial form or a lattice form, for example. Thereby, three or more parallax images can be obtained, and thus parallax images at a desired viewpoint are obtained easily.

Further, the foregoing embodiments have been described by taking as an example a case of using two parallax images obtained for stereoscopy. However, the two parallax images obtained can be used for another purpose. For example, when the two parallax images are subjected to stereo matching image processing, and a phase difference between the parallax images is obtained, a distance to an imaging object can be calculated on the basis of the phase difference.

1-16. (canceled)

17. An imaging device comprising:
an imaging lens;
an imaging element for obtaining imaging data on a basis of received light;
a liquid crystal shutter divided into at least four regions, said liquid crystal shutter being capable of controlling transmittance of a light beam going toward said imaging element in each of said regions;
a liquid crystal shutter driving section configured to switch between transmission and blockage in each of the regions in said liquid crystal shutter; and
a casing in which the imaging lens, the imaging element, and the liquid crystal shutter are housed,
wherein said liquid crystal shutter driving section switches between transmission and blockage in each of the regions in said liquid crystal shutter according to the attitude of said casing.

18. The imaging device according to claim 17, further comprising
an attitude detecting section configured to detect attitude information on an attitude of said casing,
wherein said liquid crystal shutter driving section drives said liquid crystal shutter on a basis of the attitude information detected by said attitude detecting section.

19. The imaging device according to claim 17,
wherein said liquid crystal shutter is formed by sealing a liquid crystal layer between a pair of electrodes, and
at least one of said pair of electrodes is divided into a plurality of sub-electrodes.

20. The imaging device according to claim 19,
wherein only one electrode of said pair of electrodes is divided into sub-electrodes equal in number to a number of divided regions in said liquid crystal shutter.

21. The imaging device according to claim 19,
wherein both electrodes of said pair of electrodes are divided into sub-electrodes equal in number to a number of divided regions in said liquid crystal shutter, and
the sub-electrodes are disposed so as to correspond to the respective regions of said liquid crystal shutter.

22. The imaging device according to claim 19,
wherein both electrodes of said pair of electrodes are each divided into sub-electrodes equal in number to half a number of divided regions in said liquid crystal shutter, and
the sub-electrodes opposed to each other in said pair of electrodes are disposed so as to be shifted relative to each other.

23. The imaging device according to claim 17,
wherein said liquid crystal shutter is radially divided into said plurality of regions,
said liquid crystal shutter driving section selects two or more regions adjacent to each other among said plurality of regions as unit regions in which same transmittance control is performed, according to the attitude of said casing, and
said liquid crystal shutter driving section switches between transmission and blockage in each of said unit regions.

24. The imaging device according to claim 23,
wherein said liquid crystal shutter is radially divided into four regions, and
said liquid crystal shutter driving section selects two regions adjacent to each other among said four regions as said unit regions according to the attitude of said casing.

25. The imaging device according to claim 23,
wherein said liquid crystal shutter is radially divided into eight regions, and
said liquid crystal shutter driving section selects four regions adjacent to each other among said eight regions as said unit regions according to the attitude of said casing.

26. The imaging device according to claim 17,
wherein said plurality of regions of said liquid crystal shutter each have a first sub-region for selectively transmitting first polarized light and a second sub-region for selectively transmitting second polarized light different in direction of polarization from said first polarized light.

27. The imaging device according to claim 26,
wherein said liquid crystal shutter has a liquid crystal layer sealed in between a pair of substrates, a first polarizer on the substrate on a light incidence side of said pair of substrates, and a second polarizer on the substrate on the light emission side of said pair of substrates.

28. The imaging device according to claim 27,
wherein said first polarizer includes:
a first polarized light transmitting region corresponding to said first sub-region and selectively transmitting said first polarized light; and
a second polarized light transmitting region corresponding to said second sub-region and selectively transmitting said second polarized light.

29. The imaging device according to claim 28,
wherein an electrode configured to apply a voltage to said liquid crystal layer is disposed on each of said pair of substrates, and
at least the electrode on one substrate is divided so as to correspond to said first sub-region and said second sub-region.

30. The imaging device according to claim 28,
wherein said second polarizer has a third polarized light transmitting region selectively transmitting said first polarized light and a fourth polarized light transmitting region selectively transmitting said second polarized light so as to correspond to an arrangement of said first polarized light transmitting region and said second polarized light transmitting region in said first polarizer.

31. The imaging device according to claim 26,
wherein said first sub-region and said second sub-region are equally divided in each of said plurality of regions.

32. The imaging device according to claim 31,
wherein a plurality of said first sub-regions and a plurality of said second sub-regions are disposed in each of said plurality of regions.
